(19) United States
(12) Patent Application Publication
(10) Pub. No.: US 2009/0005256 A1
(43) Pub. Date: Jan. 1, 2009

(54) Analysis of Encoded Chemical Libraries

(76) Inventors: Joshua A. Bittker, Cambridge, MA (US); James M. Coull, Westford, MA (US); Edward M. Driggers, Arlington, MA (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 11/996,929

(22) PCT Filed: Jul. 28, 2006
(86) PCT No.: PCT/US2006/029744

§ 371 Date: Sep. 9, 2008

Related U.S. Application Data
(60) Provisional application No. 60/704,164, filed on Jul. 29, 2005.
(60) Provisional application No. 60/782,064, filed on Mar. 14, 2006.

(51) Int. Cl. C40B 30/00

(52) U.S. Cl. 506/7

(57) ABSTRACT

The invention provides methods and compositions for analysis of a mixture of DNA sequences. More particularly, the invention provides methods and compositions for analysis of encoded chemical libraries having encoding nucleic acid tags (e.g., encoded chemical libraries prepared by nucleic acid-mediated chemistry) through analyzing the nucleic acid templates.

### RELATED APPLICATIONS

This application claims the benefit of and priority to U.S. Patent Application Ser. Nos. 60/704,164, filed on Jul. 29, 2005, and 60/782,064, filed on Mar. 14, 2006, the entire disclosure of each of which is incorporated by reference herein for all purposes.

### FIELD OF THE INVENTION

The invention relates generally to analysis of a mixture of DNA sequences. More particularly, the invention relates to methods and compositions useful for analysis of encoded chemical libraries having encoding nucleic acid tags (e.g., encoded chemical libraries prepared by nucleic acid-mediated chemistry) through analyzing the nucleic acid templates.

### BACKGROUND OF THE INVENTION

Nucleic acid-templated synthesis (or “DNA-programmed chemistry” or “DPC”) enables new modes of controlling chemical reactivity and allows evolutionary principles to be applied to the discovery of synthetic small molecules, synthetic polymers, and new chemical reactions. Li, et al., Angew. Chem. Int. Ed. 2004, 43, 4848-4870; Calderone, et al., Angew. Chem. Int. Ed. 2002, 41, 4104-4108; Sakurai, et al., J. Am. Chem. Soc. 2005, 127, 1660-166; Gartner, et al., Science 2004, 305, 1601-1605; Rosenbaum, et al., J. Am. Chem. Soc. 2003, 125, 13924-13925; Kanan, et al., Nature 2004, 431, 545-549.

In a DNA-programmed chemical process, a DNA tag is appended to each member of a synthetic library for the identification of any molecules of interest. The changes in the DNA sequence profile that result from one or more rounds of selection provide the key structure-activity relationship (SAR) and affinity data that allow the discovery and development of active compounds. It is desirable to analyze these sequences in a high-throughput and highly efficient manner. More particularly, there is a need for methods that allow analysis of libraries with many members (i.e., more than a few species).

### SUMMARY

The present invention is based, in part, upon the discovery of methods for analyzing mixtures of DNA sequences that provide a broad dynamic range, e.g., greater than 1000 fold, and determine the relative composition of those mixtures in a high-throughput manner.

In one aspect, the invention provides a method for analyzing a library of chemical compounds. The method includes the following. A library of encoded chemical compounds is provided, wherein the chemical compounds are encoded by identifying nucleotide sequences associated with the chemical compounds. The identifying nucleotide sequences (1) provide information on the structure or synthetic history of the identified chemical compounds and (2) have primer regions enabling real-time polymerase chain reaction (RTPCR) analysis. The identifying nucleotide sequences are subject to parallel RTPCR reactions and the cycle count values are recorded at which each identifying nucleotide crosses a pre-set detection threshold value for its corresponding fluorescent signal. The data recorded from the RTPCR reactions of the identifying nucleotide sequences is analyzed to arrive at the percentage compositions of encoded chemical compounds in the library.

In various embodiments, the identifying nucleotide sequence include two or more distinct codon regions which are separately subjected to RTPCR reactions and analyzed. The identifying nucleotide sequence may include three codon regions, for example, with codon region 1 having x distinct codons, codon region 2 having y distinct codons, and codon region 3 having z distinct codons, wherein x, y, and z are 1-40.

The library of encoded compounds may be provided by (1) preparing a library of compounds via nucleic acid-templated synthesis, wherein the synthesized compounds have identifying nucleotide sequences associated thereto; (2) mixing the prepared library with a biological target; and (3) collecting compounds having binding affinity towards the biological target thereby resulting in a library of encoded chemical compounds. Moreover, the library may be prepared by nucleic acid-templated synthesis. The identifying nucleotide sequences may be the template DNA strands associated with the products.

In another aspect, the invention provides a method for analyzing a library of chemical compounds. The method includes the following. A spatially addressed library of chemical compounds is provided, wherein the chemical compounds are associated with identifying nucleotide sequences. The identifying nucleotide sequences (1) include one or more codon regions with multiple possible codon sequences at each codon region, and (2) provide information on the structure or synthetic history of the identified chemical compounds. A plurality of probes are provided corresponding to all identifying nucleotide sequences of interest, wherein each of the probes includes a detectable moiety and a probe nucleotide sequence complimentary at least partially to an identifying nucleotide sequence of interest to be detected by the probe. A probe is contacted with the spatially addressed library of compounds under conditions allowing the hybridization of an identifying nucleotide sequence of interest, if present, and the corresponding probe nucleotide sequence. The presence of the detectable moiety corresponding to the probe nucleotide sequence is detected thereby to determine the presence of the identifying nucleotide sequence of interest. Another probe is then applied and detected to determine the presence of another identifying nucleotide sequence.

In various embodiments, each of the identifying nucleotide sequences may include 2, 3, 4 or more codon regions. Each codon region may have anywhere between 1-40 possible codon sequences. The identifying nucleotide sequences may be nucleic acid templates used in directing the preparation of a library of encoded chemical compounds by nucleic acid-templated synthesis.

In yet another aspect, the invention provides a method for analyzing a library of chemical compounds. The method includes the following. A spatially addressed library of chemical compounds is provided, wherein the chemical compounds are associated with identifying nucleotide sequences. The identifying nucleotide sequences (1) include one or more codon regions with multiple possible codon sequences at each codon region, and (2) provide information on the structure or synthetic history of the identified chemical compounds. A plurality of probes are provided corresponding to all identifying nucleotide sequences of interest, wherein each of the probes includes a detectable moiety and a probe nucleotide sequence complimentary at least partially to an identifying nucleotide sequence of interest to be detected by the probe. The plurality of probes are contacted with the spatially addressed library of compounds under conditions that allow the hybridization of the identifying nucleotide sequences of interest, if present, and the corresponding probe nucleotide sequences. The presence of the detectable moieties corresponding to the probe nucleotide sequences is detected thereby to determine the presence of the identifying sequences of interest.

In various embodiments, the plurality of probes are fluorescent probes, and the detectable moieties are fluorescent at different emission wavelengths.

In yet another aspect, the invention provides a method for analyzing a library of chemical compounds having associated oligonucleotides. The method includes the step of probing a plurality of beads for the presence of specific codons and not by base-by-base probing, wherein the specific codons are parts of the oligonucleotides that comprise pre-stored information regarding the identity or source of such oligonucleotides and the oligonucleotides are immobilized on said beads such that an individual bead has a population of substantially identical oligonucleotides.

In some embodiments, the oligonucleotides are conjugated to chemical compounds that are prepared via nucleic acid-templated chemistry and the oligonucleotides are templates in the syntheses of the chemical compounds. In some other embodiments, the oligonucleotides are conjugated to chemical compounds that are encoded with the oligonucleotides via a ligase or polymerase. The library may have anywhere from 100 to 100,000 or more members (e.g., 100, 1,000, 5,000, 10,000, 50,000 or more members), for example, the library may have from 500 to 10,000 members.

In some embodiments, the probing of the plurality of beads for codons are parallel probing of multiple oligonucleotide sequences via fluorescent imaging techniques.

In some embodiments, the chemical compounds are prepared via nucleic acid-templated chemistry and encoded by the templates in the syntheses of the chemical compounds. In some other embodiments, the chemical compounds are encoded with oligonucleotides via a ligase or polymerase.

In addition, the invention provides reaction products and libraries of compounds prepared by any of the foregoing methods.

The foregoing aspects and embodiments of the invention may be more fully understood by reference to the following figures, detailed description and claims.

### DEFINITIONS

The term, “associated with” as used herein describes the interaction between or among two or more groups, moieties, compounds, monomers, etc. When two or more entities are “associated with” one another as described herein, they are linked by a direct or indirect covalent or non-covalent interaction. Preferably, the association is covalent. The covalent association may be, for example, but without limitation, through an amide, ester, carbon-carbon, disulfide, carbamate, ether, thioether, urea, amine, or carbonate linkage. The covalent association may also include a linker moiety, for example, a photocleavable linker. Desirable non-covalent interactions include hydrogen bonding, van der Waals interactions, dipole-dipole interactions, pi stacking interactions, hydrophobic interactions, magnetic interactions, electrostatic interactions, etc. Also, two or more entities or agents may be “associated with” one another by being present together in the same composition.

The terms, “codon” and “anti-codon” as used herein, refer to complementary oligonucleotide sequences, e.g., in the template and in the transfer unit, respectively, that permit the transfer unit to anneal to the template during template mediated chemical synthesis.

The terms, “polynucleotide,” “nucleic acid”, “oligonucleotide” or “DNA” as used herein refer to a polymer of nucleotides. The polymer may include, without limitation, natural nucleosides (i.e., adenosine, thymidine, guanosine, cytidine, uridine, deoxyadenosine, deoxythymidine, deoxyguanosine, and deoxycytidine), nucleoside analogs (e.g., 2-aminoadenosine, 2-thiothymidine, inosine, pyrrolo-pyrimidine, 3-methyl adenosine, 5-methylcytidine, C5-bromouridine, C5-fluorouridine, C5-iodouridine, C5-propynyl-uridine, C5-propynyl-cytidine, C5-methylcytidine, 7-deazaadenosine, 7-deazaguanosine, 8-oxoadenosine, 8-oxoguanosine, O(6)-methylguanine, and 2-thiocytidine), chemically modified bases, biologically modified bases (e.g., methylated bases), intercalated bases, modified sugars (e.g., 2′-fluororibose, ribose, 2′-deoxyribose, arabinose, and hexose), or modified phosphate groups (e.g., phosphorothioates and 5′-N-phosphoramidite linkages). Nucleic acids and oligonucleotides may also include other polymers of bases having a modified backbone, such as a locked nucleic acid (LNA), a peptide nucleic acid (PNA), a threose nucleic acid (TNA) and any other polymers capable of serving as a template for an amplification reaction using an amplification technique, for example, a polymerase chain reaction, a ligase chain reaction, or non-enzymatic template-directed replication.

The term, “RTPCR” refers to real time PCR, a variant of the polymerase chain reaction in which a probe or dye is present to allow the quantitation of desired DNA product during the amplification process. The signal is measured at a defined point during each thermal cycle, and the resulting curve reveals the relative starting amounts of a DNA sequence of interest.

The term, “small molecule” as used herein, refers to an organic compound either synthesized in the laboratory or found in nature having a molecular weight less than 10,000 grams per mole, optionally less than 5,000 grams per mole, and optionally less than 2,000 grams per mole.

The term, “template” as used herein, refers to a molecule comprising an oligonucleotide having at least one codon sequence suitable for a template mediated chemical synthesis. The template optionally may comprise (i) a plurality of codon sequences, (ii) an amplification means, for example, a PCR primer binding site or a sequence complementary thereto, (iii) a reactive unit associated therewith, (iv) a combination of (i) and (ii), (v) a combination of (i) and (iii), (vi) a combination of (ii) and (iii), or a combination of (i), (ii) and (iii).

The term, “transfer unit” as used herein, refers to a molecule comprising an oligonucleotide having an anti-codon sequence associated with a reactive unit including, for example, but not limited to, a building block, monomer, monomer unit, molecular scaffold, or other reactant useful in template mediated chemical synthesis.

### BRIEF DESCRIPTION OF THE DRAWINGS

The invention may be further understood from the following figures in which:

FIG. 1 is a schematic representation of an exemplary embodiment of the methods for performing analysis of nucleic acid template sequences by RTPCR by individual codon.

FIG. 2 is a schematic representation of an exemplary embodiment of the methods for performing analysis of nucleic acid template sequences by RTPCR by multiple codons.

FIG. 3 is a schematic representation of an exemplary embodiment of the methods for performing analysis of nucleic acid template sequences by RTPCR using Taqman probes.

FIG. 4 is a schematic representation of an exemplary embodiment of the methods for performing sequencing of nucleic acid templates by single molecule hybridization.

FIG. 5 is a schematic representation of an exemplary embodiment of the methods for performing sequencing of nucleic acid templates by single molecule hybridization and using multi-colored probes.

FIG. 6 is a schematic representation of an exemplary embodiment of the methods for performing analysis of nucleic acid templates by parallel linkage probing (parallel codon probing).

FIG. 7 is a set of representative images collected during the parallel linkage probing process.

### DESCRIPTION OF THE INVENTION

The present invention provides high throughput and efficient methods for performing analysis of a mixture of DNA sequences, more particularly the analysis of encoded chemical libraries having encoding nucleic acid tags (e.g., encoded chemical libraries prepared by nucleic acid-mediated chemistry) through analyzing the nucleic acid templates. The methods of the present invention provide the ability to rapidly analyze the composition of a mixture of sequences. This is accomplished by quantifying the relative amounts of particular subsequences without the need for de novo (base-by-base) sequencing. Due to the nature of the encoding nucleic acid tags, which are composed of a combination of defined subsequences, the present invention enables the identification of templates through methods that determine the presence of those subsequences. The methods of the invention allow analysis of mixtures of DNA sequences with a broad dynamic range, e.g., greater than 100, preferably greater than 500, more preferably greater than 1000 fold, and determine the relative composition of those mixtures in a high-throughput manner.

In a DNA-programmed chemical process, a DNA tag is appended to each member of a synthetic library for the identification of any molecules of interest. The key components of DNA-programmed synthesis and selection include 1) synthesis by DNA-templation, 2) library selection and amplification, and 3) sequence analysis to reveal the identities of the DNA-linked molecules. The changes in the DNA sequence profile of the pool of DNA-appended (i.e., tagged) molecules that result from one or more rounds of selection provide the key structure-activity relationship (SAR) and affinity data that allow the discovery and development of active compounds. It is desirable to analyze these sequences in a high-throughput and highly efficient manner. More particularly, there is a need for methods that allow analysis of DNA-encoded libraries with more than few species and instead having a large number of library members. Such methods provide tools for analyzing libraries that contain weak binders and multiple binders, and precise relationships of differentially enriched compounds can therefore be established. Furthermore, the preferred methods are those providing broad dynamic ranges, e.g., providing library analysis at the individual sequence level, at a throughput level providing 10 to 50 fold coverage of all possible sequences (i.e., 10,000 to 50,000 sequences for the analysis of a 1,000 member library.)

In one aspect, the invention provides a method for analyzing a library of chemical compounds. The method includes the following. A library of encoded chemical compounds (e.g., small molecules, polymers) is provided, wherein the chemical compounds are encoded by identifying nucleotide sequences associated with the chemical compounds. The identifying nucleotide sequences (1) provide information on the structure or synthetic history of the identified chemical compounds and (2) have primer regions enabling RTPCR reactions. The identifying nucleotide sequences are subject to parallel RTPCR reactions and the cycle count values are recorded at which each identifying nucleotide crosses a pre-set detection threshold value for its corresponding fluorescent signal. The data recorded from the RTPCR reactions of the identifying nucleotide sequences is analyzed to arrive at the percentage compositions of encoded chemical compounds in the library.

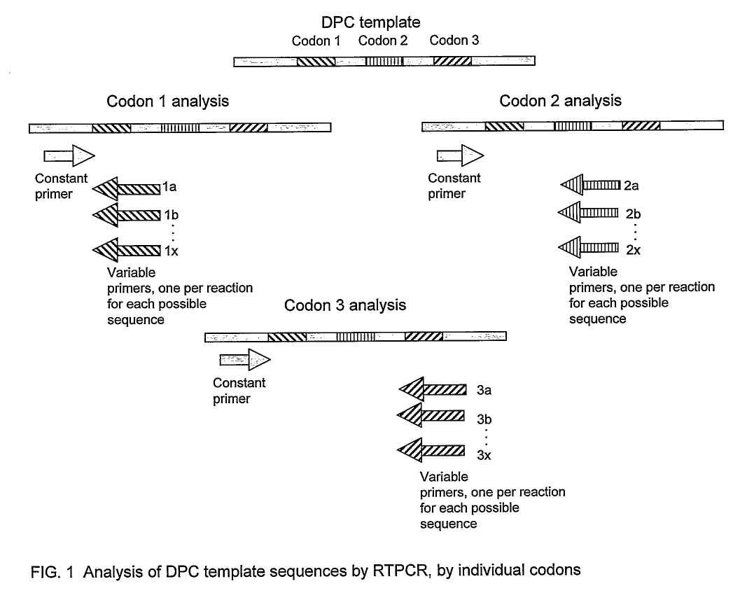

FIG. 1 is a schematic illustration of a method that employs RTPCR to measure a percent composition of each codon sequence at each coding position of a template. The method is performed by running a separate RTPCR reaction for each sequence at a given coding position, using a specific primer in each reaction that anneals to one of the possible sequences. The other primer in the pair is typically a constant primer at the end of the template, in order to minimize a) the number of reactions being run and b) the variability in efficiency between reactions, since variations in PCR efficiencies result in mis-quantitation. A subset of all possible pairs (one specific primer+constant primer) are analyzed to determine that PCR efficiencies with similar across primers. Various constructions of specific primer sequences can be evaluated, varying the number of bases annealing to the analyte templates and varying the total length of the primer by adding on non-matching bases to the 5′ end, for example, a 15-mer consisting of a 12-base matching region that is the same sequence as the reagent strands used in the DNA programmed library assembly, plus 3 bases appended to the 5′ end.

Running parallel RTPCR reactions, in which the specific primer at a codon position is varied but the amount of starting template is constant, results in a series of count values (Cts) generated (e.g., performed on a BioRad Icycler using the supplied Icycler software) indicates the crossing threshold, the cycle count at which the fluorescent signal measuring the presence of the PCR product enters logarithmic phase amplification. The Ct is determined using the maximum curvature approach to determine when the fluorescent signal trace of each reaction enters log phase. These Cts are used to calculate a hypothetical “count” (no units), equal to ½̂Ct. These “counts” are used to determine the percent composition at that codon site for each possible sequence, as illustrated in Table 1. A limitation of this analysis is that any data about the connectivity of enriched or depleted codons may be lost, since each specific RTPCR primer amplifies templates containing its cognate binding site without regard to what other codons are present on the template. If RTPCR analysis reveals enrichment of two codons at position 1 (A+B), one at position 2 (C), and two at position 3 (D+E), there are a range of possible scenarios that could have produced this pattern (for example, enrichment of templates ACD+BCE, or ACE+BCD, or enrichment of any three or all four templates.)

TABLE 1
Use Of Ct Values To Calculate % Composition By Codon

| Codon | 1a | 1b | 1c | 1d | 1e | total |
|---|---|---|---|---|---|---|
| Ct | 12.5 | 11.61 | 13.5 | 9.4 | 12.2 | |
| Count | 0.000173 | 0.000322 | 8.63E−05 | 0.00148 | 0.000213 | 0.002274 |
| % comp. | 7.6 | 14.2 | 3.8 | 65.1 | 9.3 | 100 |

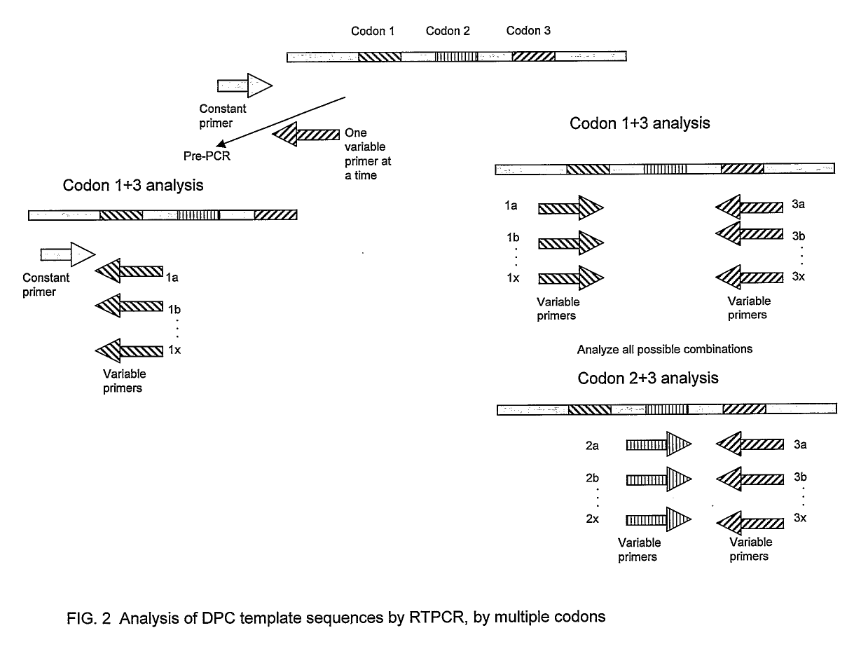

Several variations of this basic RTPCR procedure can be adopted, as illustrated in FIG. 2. One method is to pre-amplify via PCR using a specific primer at one codon position (for example, primer X), then analyze the composition of another codon in the resulting product. For example, as shown in the left portion of FIG. 2, a specific codon 3 primer can be used to generate a set of template products which can then be analyzed by RTPCR at codon position 1. This approach provides an analysis of the composition of only those templates containing the specific codon 3 used, yielding some of the linkage data lost by the above-mentioned method. A second method for obtaining linkage information, shown in the right portion of FIG. 2, is to use two variable primers instead of one constant and one variable primer, which quantitates the relative amounts of templates containing all primer pairs. One feature of these two modified methods is the exponentially increasing number of RTPCR reactions required to obtain codon linkage data. For example, if a template has two codon positions each with 10 possible codons, the simple analysis requires 20 (10+10) RTPCR reactions, compared to 100 (10×10) reactions to analyze all possible linkages.

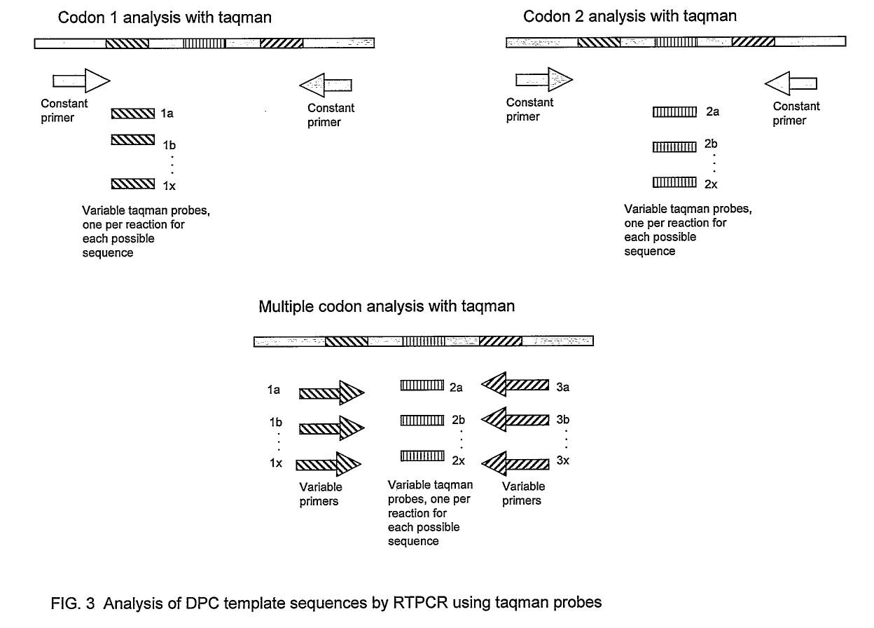

Probes may be used in RTPCR procedures. The basic method may employ the affinity of a fluorescent dye, e.g., SYBR green, for DNA duplexes. As a result, the fluorescent signal appears only when a sufficient amount of duplex PCR product has been generated. An alternative is to use a probe that is digested by the exonuclease activity of the polymerase used in PCR (“the Taqman method”). Heid et al., Genome Research 1996, 6, 986-994. Typically, the polymerase digests a probe containing a fluorophore and a quencher, liberating the fluorophore and generating a signal. For analysis of individual codons, constant primers may be used on both ends and a variable sequence probe used to query each position and possible sequence (FIG. 3, top). These fluorophores can also be designed to emit at various wavelengths, allowing the use of multiple probes in one experiment and allowing a further expansion of the linkage experiment described above. In conjunction with probes, all combinations of primers at other positions can be used to analyze all possible sequences. Thus, analyzing three codon positions, each with 10 codons, using two specific primers and a specific probe annealing between them on the template would require approximately 1,000 RTPCR reactions (fewer if probes of multiple emission wavelengths are used.)

Alternative DNA structures are commercially available that improve the annealing characteristics of short primers or probes in terms of mismatched annealing. LNAs (Locked Nucleic Acid, a novel type of nucleic acid analog that contains a 2′-O, 4′-C methylene bridge, where bridge-locked in 3′-endo conformation restricts the flexibility of the ribofuranose ring and locks the structure into a rigid bicyclic formation, conferring enhanced hybridization performance and exceptional biological stability) can be incorporated in one or more positions on RTPCR primers or probes in order to provide better discrimination between codon sequences. This may be particularly useful if a large number of sequences are used. While mismatch control can be optimized for a DPC system, RTPCR is much more sensitive to false signals from mispriming, as the product from a mismatch event, once produced in a single round of PCR, will be amplified with efficiency equal to the matched product in subsequent thermal cycling rounds.

In another aspect, the present invention provides a method for analyzing a library of chemical compounds. The method includes the following. A spatially addressed library of chemical compounds is provided, wherein the chemical compounds are associated with identifying nucleotide sequences. A spatially addressed library here refers to a mixture of compounds or sequences, each of which is located at a fixed spatial position on a solid phase or in a matrix, such that the orientation, location, and identity of the compounds or sequences are preserved. The identifying nucleotide sequences (1) include one or more codon regions with multiple possible codon sequences at each codon region, and (2) provide information on the structure or synthetic history of the identified chemical compounds. A plurality of probes are provided corresponding to all codon sequences of interest, wherein each of the probes includes a detectable moiety and a probe nucleotide sequence complimentary at least partially to a codon sequence of interest to be detected by the probe. A probe is contacted with the spatially addressed library of compounds under conditions allowing the hybridization of a codon sequence of interest, if present, and the corresponding probe nucleotide sequence. The presence of the detectable moiety corresponding to the probe nucleotide sequence is detected thereby to determine the presence of the codon sequence of interest. Another probe is then applied and detected to determine the presence of another nucleotide sequence.

This method is directed at a feature of DNA templates used in nucleic acid-templated chemistry, i.e., the variable regions in a template which are a small subset of all possible sequences. This feature can be exploited by sequencing variable regions as a block using probes rather than sequencing base by base. Drmanac et al., Adv. Biochem. Eng. Biotechnol. 2002, 77, 75-101.

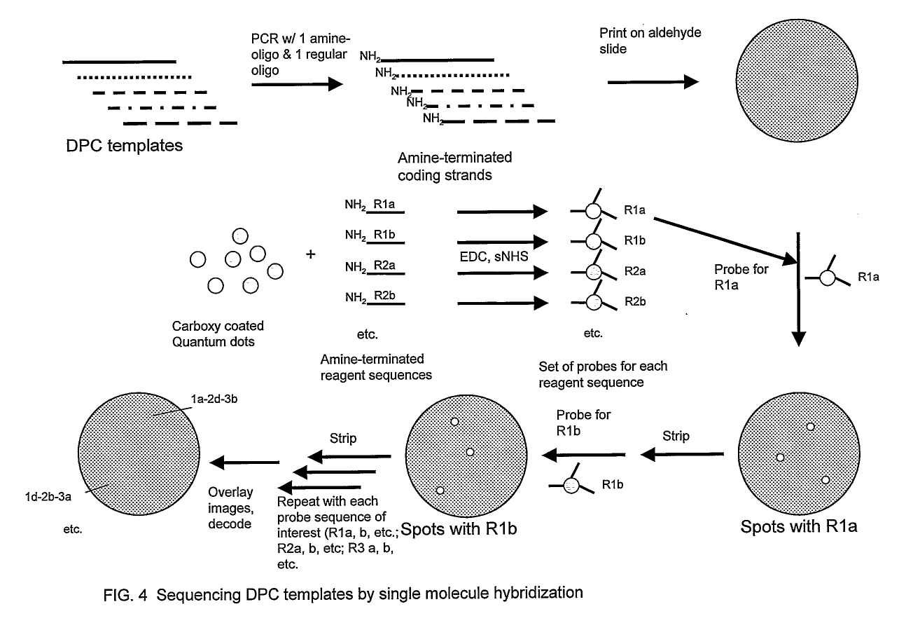

As illustrated in FIG. 4, one embodiment of this method combines sequencing by hybridization with the throughput of spatially addressable single-molecule sequencing. The DNA templates (e.g., after DNA-programmed synthesis resulting in a library of encoded compounds each with a defining DNA template having codon regions) are immobilized (e.g. by chemical crosslinking, affinity, e.g., streptavidin-biotin, or acrylamide gel fixation).

The probes are prepared by making a set corresponding to the all possible codon sequences within the codon regions (the variable regions). For example, in a template with three variable positions, each with 10 possible codon sequences, 30 probes are required, each of which corresponds to a particular codon sequence (R1a-j, R2a-j, R3a-j, such number and letter combinations denote codon position and sequences, which, for example, may correspond to building blocks in nucleic acid-templated synthesis). The probe can include any typically used fluorescent or chemiluminescent tags, including individual fluorophores, fluorospheres (Taylor et al., Anal. Chem. 2000, 72, 1979-1986), or quantum dots (Talyor and Nie, Proc. SPIE 2001, 4258, 16-24). The fluorophores attached to the probe sequences are then sequentially hybridized to the immobilized array of DPC templates.

An image is captured to determine which addresses contain the target sequence for a given probe. The probe is then removed from the array and the next probe added, an image captured, and the probe removed. This process is performed until each target sequence has been queried.

The images may then be overlaid, and each address that annealed to a probe should have exactly one signal appear for each codon position. The probe sequence which lit up an address for each codon position reveals the identity of the sequence at that address. The image analysis is similar to the process used for polony sequencing. Mitra et al., Anal. Biochem. 2003, 320, 55-65. As quality control, the algorithm may reject any sequence that has more than one signal for a given codon position (indicating overlapping templates or misannealing) and may reject any sequence that does not have a signal for all codon positions (incomplete sequences).

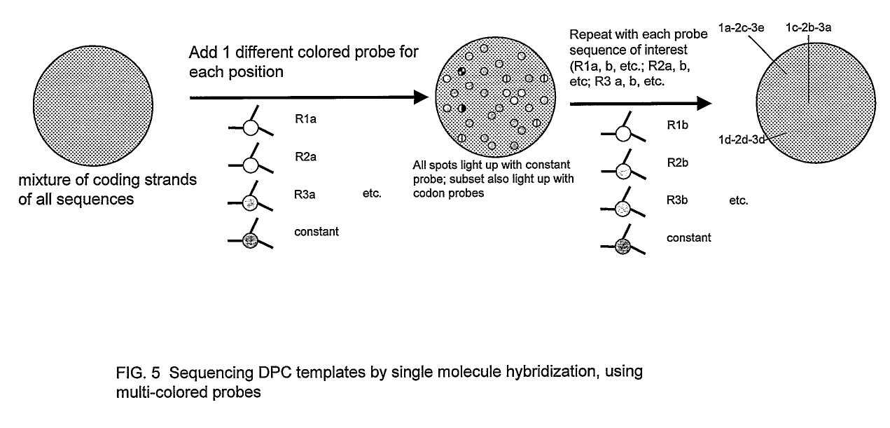

Variations that may enhance the fidelity or efficiency of sequencing include using multiple probes containing beacons with different emission wavelengths (FIG. 5). The probes are annealed at once thus reducing the number of annealing steps required. A probe can also be included to anneal to a constant region at the end of a DNA template, which should signal the presence of all immobilized templates. This image can be used as a registration system for overlaying the multiple images. Additionally, as in RTPCR, alternative probes with better annealing characteristics such as LNA can be used to improve affinity.

In yet another aspect, the invention provides a method for analyzing a library of chemical compounds. The method includes the following. A spatially addressed library of chemical compounds is provided, wherein the chemical compounds are associated with identifying nucleotide sequences. The identifying nucleotide sequences (1) include one or more codon regions with multiple possible codon sequences at each codon region, and (2) provide information on the structure or synthetic history of the identified chemical compounds. A plurality of probes are provided corresponding to all codon sequences of interest, wherein each of the probes includes a detectable moiety and a probe nucleotide sequence complimentary at least partially to a codon sequence of interest to be detected by the probe. The plurality of probes are contacted with the spatially addressed library of compounds under conditions that allow the hybridization of the codon sequences of interest, if present, and the corresponding probe nucleotide sequences. The presence of the detectable moieties corresponding to the probe nucleotide sequences is detected thereby to determine the presence of the codon sequences of interest.

While single molecule detection may be difficult due to low signal, obtaining multiple annealing sites at a given location should improve the signal by allowing multiple fluorescent probes to anneal. This can be accomplished by using the above mentioned polony method, in which clusters of the same sequence are immobilized in a gel and probed as a group. Another method is to use a circular DPC template instead of the traditional linear template. Circular templates can be multimerized by the rolling circle replication method (Lizardi et al., Nature Genetics 1998, 19, 225-232) in which a phage polymerase makes concatenated copies of a template on the array surface. In the described protocol, these concatamers are then visually enhanced using DNA condensing agents such as IgG, cations, or detergents.

To convert typical linear templates or pieces of DNA to circles competent for rolling circle replication, circular DNA can be generated by using a 5′-Iodo 3′-phosphorothioate DNA and a splint DNA that brings the two ends together. The resulting circle contains a nearly native phosphorothioate linkage and is competent for rolling circle amplification. Kool et al. Tet. Lett., 1997, 38, 5595-5598. Using this method, linear templates can be amplified by standard PCR using one primer (the “coding strand”) containing a 5′-Iodo-dT base at its 5′ terminus. Following amplification, a 5′-triphosphate 3′-phosphorothioate nucleotide can be added to the 3′ ends of the products by using terminal deoxyribonucleotidyl transferase (NEB). This will add exactly one nucleotide to the 3′ ends, and is blocked from further addition as a 3′-hydroxyl is necessary for further addition. The doubly modified template can then be circularized using a splint DNA to bring the ends together. Only the coding strand will form circles, as only the coding primer contains 5′-Iodo-dT. These circles can then be amplified by rolling circle and used for a sequencing array.

Additionally, the above probing method can be used as a general method for assigning sequences to array immobilized DNA on a micro-scale. Currently, microarrays are produced by nanodrop printing robot or by photolithography, both of which pre-define the location of all sequences. An array can be randomly generated by laying down a mixture of sequences of interest, such as from a split-pool synthesized library, and then assigning their locations by using the above described method. Following assignment by probing, the immobilized sequences can be used in a fashion analogous to traditional microarrays, but with a much higher density of sequences.

In another aspect of the invention, a library of DNA sequences (e.g., a library of small molecule-DNA conjugates) is analyzed by parallel linkage probing (or “parallel codon probing”).

In yet another aspect, the invention provides a method for analyzing a library of chemical compounds. The method includes the step of probing a plurality of beads for the presence of specific codons and not by base-by-base probing, wherein the specific codons are parts of oligonucleotides that comprise pre-stored information regarding the identity or source of such oligonucleotides and the oligonucleotides are immobilized on said beads such that an individual bead has a population of substantially identical oligonucleotides. In one embodiment, the probing of the plurality of beads for codons are parallel probing via fluorescent imaging techniques.

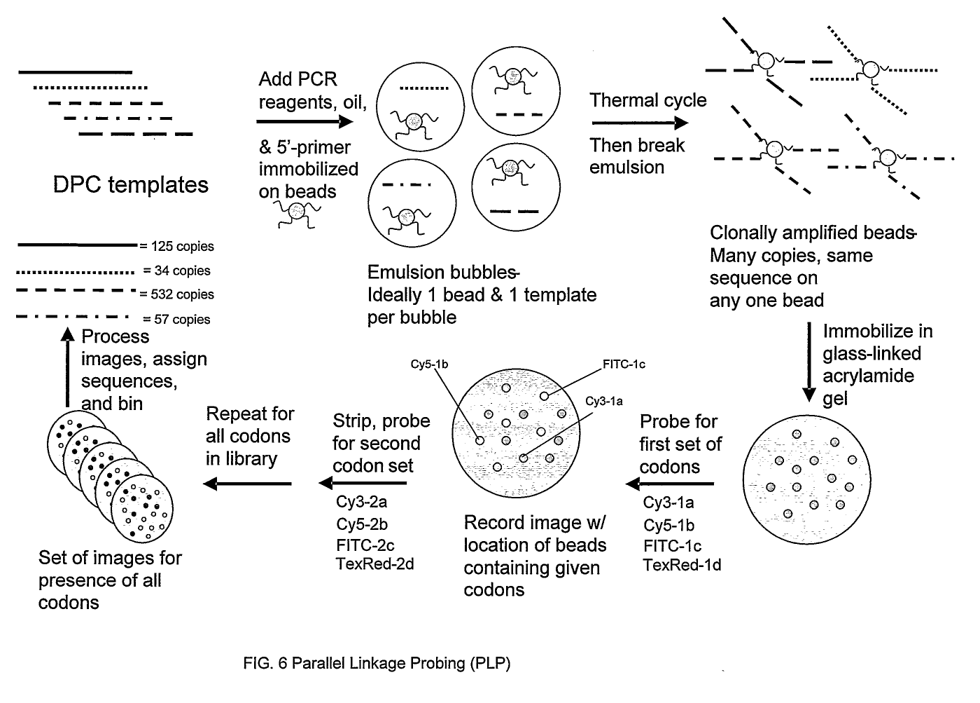

Illustrated in FIG. 6 is an exemplary embodiment of the parallel linkage probing method. Pools of DNA are amplified by PCR until a product is visible on an agarose gel. Then, this product (e.g., 100 amol) is used in a water-in-oil emulsion PCR to create magnetic beads with multiple copies of a single sequence on each bead. DNA sequences are amplified using one biotinylated primer that is bound to the streptavidin magnetic beads, resulting in one strand of the PCR being linked to the beads.

The beads are washed and treated (e.g., with 0.1N sodium hydroxide) to remove the complimentary unlinked DNA strand, then washed again.

The beads are then immobilized in an acrylamide gel. The gel is polymerized on a glass microscope cover slip that had previously been activated with Bind Silane (Amersham-Pharmacia). This results in the gel being covalently linked to the glass slide. The polymerization of the gel occurs slowly (e.g., 1 h), allowing the beads to settle into one plane against the slide. Multiple pools can be analyzed simultaneously by casting several smaller gels onto one cover slip, each gel containing beads amplified from different input DNA (e.g., template oligonucleotides from nucleic acid-templated syntheses).

The slide is then assembled into a heated flowcell and mounted on a microscope. The beads are queried with a set of probes complimentary to a subset of the sequences of interest. Each probe in a set is labeled with a different fluorophore, for example fluorescien, Cy3, or Cy5. The probes are annealed at about 55° C., for example, and gradually cooled to room temperature, whereupon they are washed with buffer to remove unannealed probes. The gel is then imaged with white light as well as the appropriate filter for each fluorophore used. This records the location of each bead and the presence or absence of each query sequence (e.g., 1a, 1b, etc.), as illustrated in FIG. 6. The probes are then stripped from the beads (e.g., using two washes of 50% formamide in water at 55° C.). The next set of probes is then added and the process repeated until all sequences of interest have been queried. The process can be fully automated using a motorized stage and filter wheel and a syringe pump, slide heater, and autosampler.

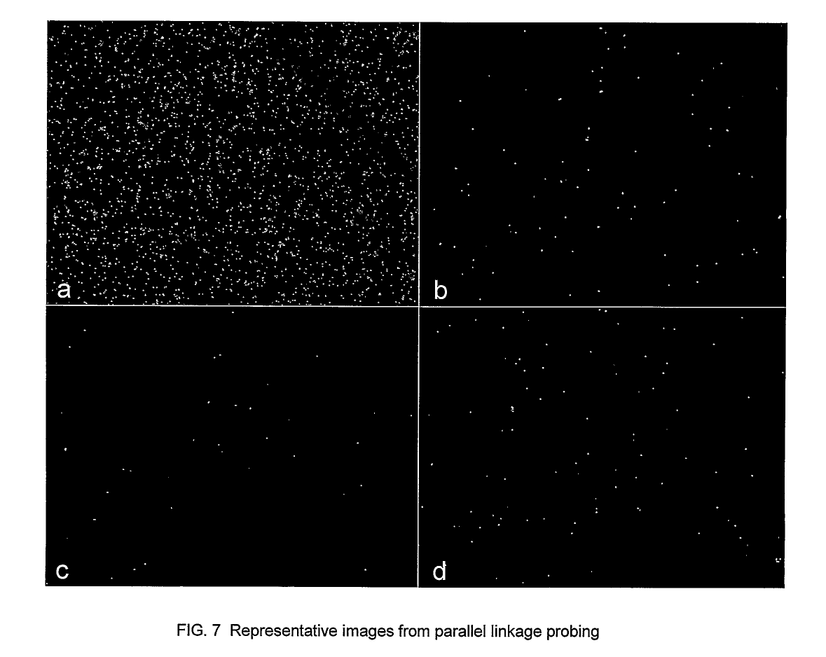

FIG. 7 shows a representative set of images collected in one cycle of the parallel linkage probing process. FIG. 7a is an image of all the beads present in a field of view, collected using a phase contrast lens. FIG. 7b-d are fluorescent images that result from simultaneously probing these beads with three different probes, each with a different fluorophore linked to a different sequence. For example, FIG. 7b reveals those beads containing a sequence complementary to probe 1, FIG. 7c shows those beads containing a sequence complementary to probe 2, and FIG. 7d shows those beads containing a sequence complementary to probe 3.

The resulting images are then analyzed by aligning them and determining the position of each bead under white light. The position of each fluorescent signal is then correlated to this bead position map, and the presence of each of the sequences of interest on each bead is determined.

Background information may be found in WO 2005/082098A2 and Shendure et al. (2005) Science, 309, 1728-1732.

In addition, the invention provides reaction products and libraries of compounds prepared and/or analyzed by any of the foregoing methods.

Various aspects of nucleic acid-templated chemistry are discussed in detail below. Additional information may be found in U.S. Pat. No. 7,070,928 by Liu et al., U.S. Patent Application Publication Nos. 2004/0180412 A1 (U.S. Ser. No. 10/643,752) by Liu et al. and 2003/0113738 A1 (U.S. Ser. No. 10/101,030) by Liu et al., US patent application titled “Codons for Nucleic Acid-Mediated Chemical Reactions and Use Thereof” by Askenazi et al. (Atty. Docket No. ENS-005PR, Ser. No. 11/372,994), and PCT international patent application PCT/US2006/021088 titled “Anchor-Assisted Fragment Selection and Directed Assembly” by Stern et al.

The following examples contain important additional information, exemplification and guidance that can be adapted to the practice of this invention in its various embodiments and equivalents thereof. Practice of the invention will be more fully understood from these following examples, which are presented herein for illustrative purpose only, and should not be construed as limiting in anyway.

### EXAMPLES

### Example 1

### Analysis of Nucleic Acid Template Sequences by RTPCR

A mixture of DNA templates consisting of a 5′ constant region, a 3′ constant region, and three variable codons was analyzed using RTPCR reactions. The template sequences consisted of:

5′- CAGACGTCAC-XXXXXX-CTCAC-YYYYYY-CACTC-ZZZZZZ-CCACTACAAC-3′
(SEQ ID NO: 1) (SEQ ID NO: 2)

Where XXXXXX consists of one of the following position 1 codons:

CGTCAA
CACGAA
CCGTAA
AACCGA
GCACTA
CTCCTA
CCTGTA
GAAACC
ATGACC
TTCTCC

YYYYYY consists of one of the following position 2 codons:

CATTCC
TACAGC
CTTAGC
TAGCTC
AGTCTC
AACGTC
CTGTTC
GCTTTC
CCTAAG
TACCAG
CTCTAG

ZZZZZZ consists of one of the following position 3 codons:

CTAACG
CACATG
CGCAAT
CTGCAT
GCTCAT
CCAGAT
TTCCGT
CATCGT
CGACTT
GACCTT
CCCTTT

The mixture of templates was pre-amplified by PCR using Promega PCR mastermix and the 5′ constant sense primer 5′-TAGGCTACGACAGACGTCAC-3′ (SEQ ID NO: 3) and the 3′-constant antisense primer 5′-CACTCCGACGGTTGTAGTGG-3′ (SEQ ID NO: 4), with each primer at 0.5 μM. Thermal cycling was performed at 94° C. for 30 seconds, 50° C. for 30 seconds, and 72° C. for 10 seconds, repeated between 15 and 30 times. The mixture was amplified until an aliquot of the reaction was visible on and agarose electrophoresis gel stained with ethidium bromide. The concentration of the PCR reaction was determined by densitometry of the agarose gel, comparing against a standard mass marker.

The library was subjected to RTPCR analysis using Biorad IQ Sybr green master mix, the 5′-constant primer indicated above, and a series of specific primers, with each primer at 50 μM. For position 1 analysis, the primers were of the sequence 5′-TGTGAGxxxxxxGTG′-3′, where xxxxxx is the reverse complement of the position 1 codons listed above. For position 2 analysis, the primers were of the sequence 5′-ACTGTGyyyyyyGTG-3′, where yyyyyy is the reverse complement of the position 2 codons listed above. For position 3 analysis, the primers were of the sequence 5′-TAGTGGzzzzzzGAG-3′, where zzzzzz is the reverse complement of the position 3 codons listed above. Included in each 50 μL reaction was 0.1 fmol of the quantitated pre-amplified template. The reactions were cycled with the same conditions as above on a BioRad Icycler, and the SYBR green fluorescent signal was measured at both steps 2 and 3 of the thermal cycling program. The software automatically converts the signals to an amplification curve and calculates a crossing threshold, which was used in the percent composition analysis for each codon position. The calculations were performed as described in the text above.

### Example 2

### Analysis of Nucleic Acid Template Sequences by Parallel Linkage Probing

### Part 1—Emulsion PCR

Generation of 5′ Constant Bead Stock

### Reagents and Supplies:

250 μM 5′-constant primer, 5′-dualBiotinylated
Dynal MyOne C Streptavidin beads
Binding buffer: 5 mM Tris pH 7.5, 0.5 mM EDTA, 1 M NaCl
1×TE

### Procedure

1. Mix 100 μL resuspended beads with 100 μL binding buffer. Put on magnet and remove all liquid.
2. Wash 2×200 μL binding buffer.
3. Resuspend beads in 192 μL binding buffer.
4. Add 8 μL 250 μM 5′DualBio 5′-constant primer. Rock 25° C. 20 min.
5. Remove all liquid on magnet.
6. Wash 2×200 μL binding buffer.
7. Wash 1×200 μL TE.
8. Resuspend in 200 μL TE. Beads are now 5×10⁹ per mL.

Emulsion PCR

### Reagents and Supplies:

10× Invitrogen PCR buffer
1 M MgCl₂
25 mM dNTP
5 μM 5′ constant primer
1 mM 3′ constant primer
Platinum Taq DNA polymerase (Invitrogen)
Reagent H₂O
5′ constant beads—see recipe above
Flea stir bars (2×7 mm)
Corning 2 mL cryo round bottom vials
Mineral oil
10% Span 80 in mineral oil (make up using syringes for accurate volume)
Tween 80
Triton x-100
15 mL conical tubes
100 μM DNA template mixture samples

### Oil Phase Preparation Procedure

Each emPCR reaction uses 75 μL of aqueous phase and 400 μL of oil phase.
1. Combine the following:
   545 μL mineral oil
   450 μL 10% span 80 in oil—make 10 mL at a time using a 10 mL (for 9 mL oil) and a 1 mL (for 1 mL Span 80) syringes and vortex thoroughly. If there is a white precipitate, discard and make fresh (every ˜3 weeks)
   4 μL Tween 80
   0.5 μL triton x-100
2. Allow oil to settle for several minutes to remove air bubbles.
3. Add 1 flea stir bar to each 2 mL Corning cryo tube (discard caps) for each reaction.
4. Add 400 μL of oil phase mix to each tube.
5. Put in rack on stir plate.

### Aqueous-Phase Preparation Procedure

75 μL/reaction—make 0.5-1 extra reaction to allow for foaming and pipetting error.
7.5 μL 10× buffer (to 1×)
1.41 μL 1M MgCl₂ (18.8 mM)
10.5 μL 25 mM dNTP (3.5 mM)
1.875 μL 1 mM 3′-constant primer (25 μM)
0.75 μL 5 uM 5′-constant primer (50 nM)
4.7 μL (5×10⁹ beads/mL) 5′-constant loaded beads (well mixed and resuspended)
4.2 μL 5 U/μL Platinum taq (21 U)
43 μL H₂O
74 μL

Distribute 74 μL of Promega PCR mastermix into 1.5 μL conical tubes.

Add μL 100 μM template mixture sample to each tube.

Stir the oil phase on a stir plate at 1400 rpm. Add the aqueous phase dropwise into the stirring oil at a rate of 75 μl/min (˜1 drop/6 seconds.)

Stir for 30 minutes at 1400 rpm.

Distribute the contents of one tube into 8 wells in a PCR plate, 50 μL per well.

Cover PCR plate with film and run with program as follows.

1. 94° C. 2 minutes
2. 94° C. 15 seconds
3. 57° C. 30 seconds
4. 70° C. 75 seconds
5. Goto 2, 119 more times
6. 72° C. 2 minutes
7. 4° C. forever

Post emPCR Cleanup

### Reagents and Supplies

1×TE
NX2 buffer (100 mM NaCl, 10 mM Tris pH 7.5, 1 mM EDTA pH 8.0, 0.1% triton x-100)
MPC magnet
Vortexer
Centrifuge
1. Combine each set of 8×50 μL emulsion reactions into a 1.5 mL centrifuge tube. Draw from each well several times as the solution is viscous.
2. Add 800 μL NX2 buffer. Vortex thoroughly 20 sec. Spin 13,200 rpm 90 sec.
3. Remove supernatant, trying to remove as much oil from top of supernatant as possible. Do not disturb brown & white pellet.
4. Add 800 μL NX2, vortex 20 sec, spin 9000 rpm 90 sec. The vortexing in these steps should resuspend as much of the oily pellet as possible.
5. Remove oil and supernatant, add 700 μL NX2, vortex 20 sec, spin 9000 rpm 90 sec.
6. Remove oil and supernatant, add 600 μL NX2, vortex 20 sec, spin 9000 rpm 90 sec.
7. Remove oil and supernatant, put on magnet and remove all liquid.
8. Wash 3×250 μL TE, being careful not to pick up any beads.
9. If pouring gel immediately, proceed to next step. If not, add 50 μL TE and store beads at 4° C.

### Part 2—Polyacrylamide Gel Preparation

Reagents and Supplies
40% 19:1 acrylamide:bis solution (Roche)
Rhinohide gel strengthener (Molecular Probes)
Solid ammonium persulfate (APS)
TEMED (tetramethyl ethylene diamine)
1×TE
Bind-silane activated slides (see recipe below)
Microscope slide gel template—custom ordered (see pattern below)
Printout of gel template
3 15 mL falcon tubes

Bind-Silane Activation of Cover Slips (Makes 20 Cover Slips)

### Reagents and Supplies

Bind-silane (Amersham)
Glacial acetic acid
˜20 #1.5 40 mm round coverslips
1% triton x-100
1. Load coverslips into a rack to keep them separated and allow washing.
2. Put rack in 400 mL beaker. Fill with 1% triton x-100 to cover coverslips (˜300 mL). Put on orbital shaker, shake 20 minutes.
3. While washing coverslips, prepare bind-silane solution: In 500 mL Erlenmeyer flask, mix 350 mL H₂O, 1300 μL Bind Silane, 73 μL glacial acetic acid. Stir with stir bar 15 minutes.
4. Rinse coverslips 3×300 mL H₂O. Put back in beaker and cover with Bind Silane solution. Put on orbital rocker 1 hour.
5. Discard solution, wash coverslips 3× H₂O 1×95% EtOH. Lay slides out in a breeze (e.g., on edge of fume hood) to dry. Wrap in lens tissue and store in dessicator.

Gel Preparation

### Reagent Preparation:

1. Prepare 0.5% APS solution in a 15 mL Falcon tube. Add 25-50 mg APS to appropriate amount of H₂O (5 to 10 mL).
2. Make TE-APS in a 15 ml Falcon tube: 115 μL of 0.5% APS+885 μL 1× TE.
3. Make 5% TEMED in a microcentrifuge tube: 5 μL TEMED: 95 μL H₂O.
4. Make gel stock: In 15 mL falcon tube, mix 250 μL 40% acrylamide, 100 μL rhinohide, 100 μL 5% TEMED.
5. Degas gel stock and TE-APS: loosen caps and place on lyophilizer 15 seconds.

### Gel Pouring

1. Remove magnets from the area
2. With a marker, label one side of a coverslip with a backwards B at position desired for gel 1 (B=begin).
3. Place coverslip on a gel template, with marked side down, so the B reads correctly:
   Resuspend beads in 20 μL TE-APS by vortexing thoroughly
4. Lay out one eppendorf tube in a rack per gel, with lids open.
5. In center of each lid, place 0.35 μL of gel mix.
6. On edge of lid, put 1.15 μL of gel suspension in TE-APS. Do not mix liquids yet.
7. When all samples are ready, mix beads and gel from one lid—pipette up and down with 10 μL pipette, and place on coverslip at position of x. Proceed quickly for all gels, taking no more than 2 minutes total.
8. When all beads have been spotted, slowly drop a microscope slide mask onto beads of liquid. Make sure mask side of slide is down.
9. Polymerize 1 hour at room temperature.
10. Pull coverslip off of mask.
11. Rinse gels under stream of H₂O. The gel side is up when the B reads correctly. If using immediately, proceed to flow cell assembly (below). Be sure to keep gels wet. If not using immediately store the coverslip submerged in H₂O.

### Part Three: Probing

Assemble the coverslip into a flowcell (Bioptechs) using a 500 μm round gasket spacer. Mount the flow cell on the microscope. Attach flow hoses from syringe pump and to waste, and attach flow cell temperature controller. Prime the system—prime all fluids and remove bubbles from flow cell by passing 1 mL through forward, 1 mL reverse, and 1 mL forward again.

Probe Set Preparation
Prepare 4 color probe sets from custom ordered stocks (IDT. Coralville, Iowa). Final probe concentration is 50 mM in 6×SSPE, 0.1% triton x-100.
For a 9×12×12×12 library, the probe set combinations are as follows, where each number represents a codon position (1, 2, 3, or 4) and each letter represents a unique codon sequence. In all, there are 45 unique sequences that are probed in this example:

| Probe set # | Alexa488 | Cy3 | Cy5 | CalFluor610 |
|---|---|---|---|---|
| 1 | 1A | 1B | 1C | 1D |
| 2 | 1E | 1F | 1G | 1H |
| 3 | 1I | 1J | 1K | 1L |
| 4 | 2A | 2B | 2C | 2D |
| 5 | 2E | 2F | 2G | 2H |
| 6 | 2I | 2J | 3K | 2L |
| 7 | 3A | 3B | 3C | 3D |
| 8 | 3E | 3F | 3G | 3H |
| 9 | 3I | 3J | 3K | 3L |
| 10 | 4A | 4B | 4C | 4D |
| 11 | 4E | 4F | 4G | 4H |
| 12 | None | None | 4I | None |

Prepare stock solutions of water, 50% formamide/water, or Wash 1 E (10 mM Tris pH 7.5, 50 mM KCl, 2 mM EDTA pH 8.0, 0.01% triton x-100). ˜40 mL of each is required per run.

Probing and Acquisition Procedure

Each cycle consists of three steps—stripping, probing, and acquisition. There is also an initial focal map collection.

Focal map—Each minigel is imaged using a 10× phase objective under bright field illumination. The microscope control software uses an autofocus routing to record the in-focus x, y, and z coordinates of each of 9 fields of view for each of 8 gels. It is necessary to have stage encoders for all three dimensions to ensure good results.

Stripping—The microaqueduct slide is preheated to 55° C. All flow rates to the flow cell are 2 mL/min. The gels are washed with 1 mL 50% formamide in water for 90 seconds and 1 mL water for 30 seconds (the delay times are to allow the flow cell to heat back up after room temperature solutions are passed through.) This cycle is repeated once more.

Probing—500 μL of 50 nM probe is added to the flow cell, followed by 100 μL wash 1 E (10 mM tris-HCl pH 7.5, 50 mM KCl, 2 mM EDTA, 0.01% triton x-100). The gels are heated back up to 55° C., then allowed to cool slowly to 25° C. over the course of four minutes. The gels are then washed twice with 1 mL wash 1 E buffer.

Acquisition—Each field of view has five images collected per probe set a bright field image and an image for each of the fluorescent dyes. The focal position is determined using the focal map acquired prior to the run; for each round of acquisition, the first field of each gel is subjected to autofocusing. Subsequent fields are not autofocused; rather, the z position is determined using the z differential from field 1 seen in the initial focal map. Due to chromatic aberration of the 10× lens, it is also necessary to adjust the z position for acquisition of each dye.

The cycle of stripping, probing, and acquisition is repeated for each dye set listed above (in this case, 12 cycles.)

Data analysis—The collected images are analyzed as follows. Each bright field image is subject to a simple thresholding to locate the beads (under phase contrast, the beads appear as bright spots.) The locations of the beads for each bright field image is transferred as a mask to the four fluorescent images collected in the same cycle. The intensities at the location of each bead are recorded. All data is exported as a series of x,y coordinates and intensities; segments that are too large to be one bead (clumps) are deleted. Images from different cycles are aligned by comparing a subset of the bright field coordinates from each cycle and finding the maximal overlap.

Sequences are then called by determining whether the intensity at each bead coordinate corresponding to a given probe is above a background threshold. This threshold is determined by calculating the average intensity and standard deviation for each probe color at all bead locations for all probes of that color. Beads that have exactly one probe per position passing the threshold test are called as complete sequences; beads with multiple probes at one position or lacking a probe at a position are discarded as polyclonal and incomplete sequences, respectively.

### INCORPORATION BY REFERENCE

The entire disclosure of each of the publications and patent documents referred to herein is incorporated by reference in its entirety for all purposes to the same extent as if each individual publication or patent document were so individually denoted.

### EQUIVALENTS

The invention may be embodied in other specific forms without departing form the spirit or essential characteristics thereof. The foregoing embodiments are therefore to be considered in all respects illustrative rather than limiting on the invention described herein. Scope of the invention is thus indicated by the appended claims rather than by the foregoing description, and all changes that come within the meaning and range of equivalency of the claims are intended to be embraced therein.

1. A method for analyzing a library of chemical compounds, the method comprising:
(a) providing a library of encoded chemical compounds, wherein the chemical compounds are encoded by identifying nucleotide sequences associated with the chemical compounds, the identifying nucleotide sequences (1) providing information on the structure or synthetic history of the identified chemical compounds and (2) having primer regions enabling RTPCR reactions;
(b) subjecting the identifying nucleotide sequences to parallel RTPCR reactions and recording the cycle count values at which each identifying nucleotide crosses a pre-set detection threshold value for its corresponding fluorescent signal;
(c) analyzing the data recorded from the RTPCR reactions of the identifying nucleotide sequences to arrive at the percentage compositions of encoded chemical compounds in the library.

2. The method of claim 1 wherein the identifying nucleotide sequence comprises two or more distinct codon regions which are separately subjected to RTPCR reactions and analyzed.

3. The method of claim 1 wherein the identifying nucleotide sequence comprises three codon regions with codon region 1 having x distinct codons, codon region 2 having y distinct codons, and codon region 3 having z distinct codons, wherein x, y, and z are 1-40.

4. The method of claim 1 wherein the library is provided by
(a1) preparing a library of compounds via nucleic acid-templated synthesis, wherein the synthesized compounds having identifying nucleotide sequences associated thereto;
(a2) mixing the prepared library with a biological target; and
(a3) collecting compounds having binding affinity towards the biological target thereby resulting in a library of encoded chemical compounds.

5. The method of claim 1 wherein the library is prepared by a nucleic acid-templated synthesis and the identifying nucleotide sequences are the template DNA strands associated with the products.

6. A method for analyzing a library of chemical compounds, the method comprising:
(a) providing a spatially addressed library of chemical compounds, wherein the chemical compounds are associated with identifying nucleotide sequences, the identifying nucleotide sequences (1) comprising one or more codon regions with multiple possible codon sequences at each codon region, and (2) providing information on the structure or synthetic history of the identified chemical compounds;
(b) providing a plurality of probes corresponding to all identifying nucleotide sequences of interest, wherein each of the probes comprises a detectable moiety and a probe nucleotide sequence complimentary at least partially to an identifying nucleotide sequence of interest to be detected by the probe;
(c) contacting a probe with the spatially addressed library of compounds under conditions allowing the hybridization of an identifying nucleotide sequence of interest, if present, and the corresponding probe nucleotide sequence;
(d) detecting the presence of the detectable moiety corresponding to the probe nucleotide sequence thereby determining the presence of the identifying nucleotide sequence of interest; and
(e) repeating (c) and (d) with another probe to determining the presence of another identifying nucleotide sequence.

7. The method of claim 6 wherein each of the identifying nucleotide sequences comprises 2 or more codon regions.

8. The method of claim 6 wherein each of the identifying nucleotide sequences comprises 3 or more codon regions.

9. The method of claim 6 wherein each codon region has 1-40 possible codon sequences.

10. The method of claim 6 wherein the identifying nucleotide sequences are nucleic acid templates used in directing the preparation of a library of encoded chemical compounds by nucleic acid-templated synthesis.

11. A method for analyzing a library of chemical compounds, the method comprising:
(a) providing a spatially addressed library of chemical compounds, wherein the chemical compounds are associated with identifying nucleotide sequences, the identifying nucleotide sequences (1) comprising one or more codon regions with multiple possible codon sequences at each codon region, and (2) providing information on the structure or synthetic history of the identified chemical compounds;
(b) providing a plurality of probes corresponding to all identifying nucleotide sequences of interest, wherein each of the probes comprises a detectable moiety and a probe nucleotide sequence complimentary at least partially to an identifying nucleotide sequence of interest to be detected by the probe;
(c) contacting the plurality of probes with the spatially addressed library of compounds under conditions allowing the hybridization of the identifying nucleotide sequences of interest, if present, and the corresponding probe nucleotide sequences; and
(d) detecting the presence of the detectable moieties corresponding to the probe nucleotide sequences thereby determining the presence of the identifying nucleotide sequences of interest.

12. The method of claim 11 wherein the plurality of probes are fluorescent probes and the detectable moieties are fluorescent at different emission wavelengths.

13. A method for analyzing a library of chemical compounds having associated oligonucleotides, the method comprising the step of probing a plurality of beads for the presence of specific codons and not by base-by-base probing, wherein the specific codons are parts of the oligonucleotides that comprise pre-stored information regarding the identity or source of such oligonucleotides and the oligonucleotides are immobilized on said beads such that an individual bead has a population of substantially identical oligonucleotides.

14. The method of claim 13 wherein the probing of the plurality of beads for codons are parallel probing of multiple oligonucleotide sequences via fluorescent imaging techniques.

15. The method of claim 13 wherein the oligonucleotides are conjugated to chemical compounds that are prepared via nucleic acid-templated chemistry and the oligonucleotides are templates in the syntheses of the chemical compounds.

16. The method of claim 13 wherein the oligonucleotides are conjugated to chemical compounds that are encoded with the oligonucleotides via a ligase or polymerase.

17. The method of claim 13 wherein the library of compounds is of the size of 100 to 100,000 members.

18. The method of claim 13 wherein the library of compounds is of the size of 500 to 10,000 members.

19. The method of claim 13 wherein the library of compounds has more than 100,000 members.


SEQUENCE LISTING (4 sequences)

SEQ ID NO: 1 - DNA, 10 bp, Artificial
  5′ end constant portion of template
cagacgtcac

SEQ ID NO: 2 - DNA, 10 bp, Artificial
  3′ end constant portion of template
ccactacaac

SEQ ID NO: 3 - DNA, 20 bp, Artificial
  5′ constant sense primer
taggctacgacagacgtcac

SEQ ID NO: 4 - DNA, 20 bp, Artificial
  3′-constant antisense primer
cactccgacggttgtagtgg